(19) United States
(12) Patent Application Publication
(10) Pub. No.: US 2002/0108114 A1
(43) Pub. Date: Aug. 8, 2002

(54) System and method for presenting DVD bulletin board screen personalized to viewer

(75) Inventors: Hiroaki Shinohara, San Diego, CA (US); Ben Feingold, Beverly Hills, CA (US); Akira Shimazu, San Diego, CA (US)

Correspondence Address: John L. Rogitz, Atty of Record, Suite 3120, 750 "B" Street, San Diego, CA, 92101, US

(73) Assignee: SONY CORPORATION, Tokyo (JP)

(21) Appl. No.: 09/991,492

(22) Filed: Nov. 21, 2001

Related U.S. Application Data
(60) Provisional application No. 60/267,680, filed on Feb. 8, 2001.

(51) Int. Cl. G06F 3/00; H04N 5/445; H04N 7/173; H04N 7/16

(52) U.S. Cl. 725/46; 725/134; 725/142; 725/51

(57) ABSTRACT

A system and method for presenting additional movie/DVD content listings of the same genre as a DVD movie, after a viewer has watched the DVD movie. A personalized bulletin board screen can be presented on a TV, with the screen listing additional content likely to be of interest to the viewer, based on the movie just watched. The bulletin board screen can be updated periodically over the Internet, such that an older DVD can be played and an updated bulletin board screen displayed with content that might, for example, star an actor in the just-watched DVD movie, or otherwise be of interest to a person who just watched the DVD movie.

### RELATED APPLICATIONS

This application claims priority from provisional U.S. patent application serial No. 60/267,680, filed Feb. 8, 2001.

### BACKGROUND OF THE INVENTION

1. Field of the Invention

The present invention relates generally to television systems.

2. Description of the Related Art

Televisions and computers have become ubiquitous, and since both usually entail a visual display, efforts have been made to integrate both functions into a single system. In this way, a consumer need not purchase and operate two separate systems, which can burden some consumers who, while familiar with operating a television and its remote control, might not be familiar with operating, for example a computer enabled with internet functionality.

To the extent that attempts have been made to combine television with Internet features, it has generally been with the focus of producing what might be thought of as a “lean forward” system. That is, TV/computers or web-based TV hybrids have typically been more oriented toward productivity, generally thought of as a computer system characteristic, and less toward entertainment (“lean back”), generally regarded as a television system characteristic. It is not just the dichotomy between productivity and entertainment that distinguishes a “lean forward” experience from a “lean back” experience, however. As contemplated herein, “lean back” activities can extend to purchasing products that are advertised on TV, as opposed to, e.g., offering products for sale. In any case, with the above-mentioned critical observation of the present invention in mind, it can readily be appreciated that the differences between a system designed for “lean forward” experiences and a system designed for “lean back” experiences can be both subtle and profound.

In the above context, the present invention recognizes that in one aspect of a lean back experience, a viewer might be interested in obtaining further programming that is related to something the viewer found interesting in, for instance, a digital video disk (DVD) program that the viewer displays on the TV. For example, a viewer might be interested in viewing additional movies that star an actor featured on a DVD movie. Conventionally, the viewer would have to manually browse for such programming, or for related products, which can be cumbersome and time-consuming and which might be done after the viewer's interest has waned. The present invention critically observes that it would be advantageous to provide a TV viewer with a means to obtain recommended programming/products based on a viewer selection of DVD content in a manner that is more convenient than is currently afforded.

### SUMMARY OF THE INVENTION

A system includes a TV and a disk player coupled to the TV for playing disks having content thereon. A processor causes a bulletin board screen to be displayed on the TV based on the disk. The screen includes content recommendations that are personalized for a viewer.

In another aspect, a system for returning recommendations related to a recorded program includes a TV, and a DVD player coupled to the TV. The DVD player includes a processor that returns recommendations for further viewing based on viewer preferences, such that the recommendations are personalized to the viewer. In one exemplary illustration, the viewer preferences are established by a DVD played on the DVD player, and the recommendations are presented in a bulletin board screen displayed on the TV. The recommendations may include DVD releases and theater movie releases, and may be provided in a language selected by a viewer.

In a preferred embodiment an input device can be manipulated to cause the bulletin board screen to be displayed. Also, a storage is preferably accessible to the processor for storing updated bulletin board screens. The updated screens can be received from a wide area computer network (WAN) or from a newer DVD.

In any case, when the processor determines that the bulletin board screen is to be displayed, the processor first determines whether a corresponding updated screen is in the storage. If so, the processor retrieves the updated screen for display. Otherwise, the processor displays a bulletin board screen stored on the DVD disk.

In yet another aspect, a method for providing and recommending audio-video programs and/or content based on a viewer selection of disk-stored content played on a TV includes determining an identity of the disk-stored content. The method also includes, based on the identity of the content, displaying a bulletin board screen personalized for a viewer of the disk-stored content. As contemplated herein, the bulletin board screen lists recommendations for content other than the disk-stored content.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of the system of the present invention;

FIG. 2 is a flow chart of the present logic; and

FIG. 3 is a schematic view of a bulletin board screen.

### DETAILED DESCRIPTION OF THE PREFERRED EMBODIMENTS

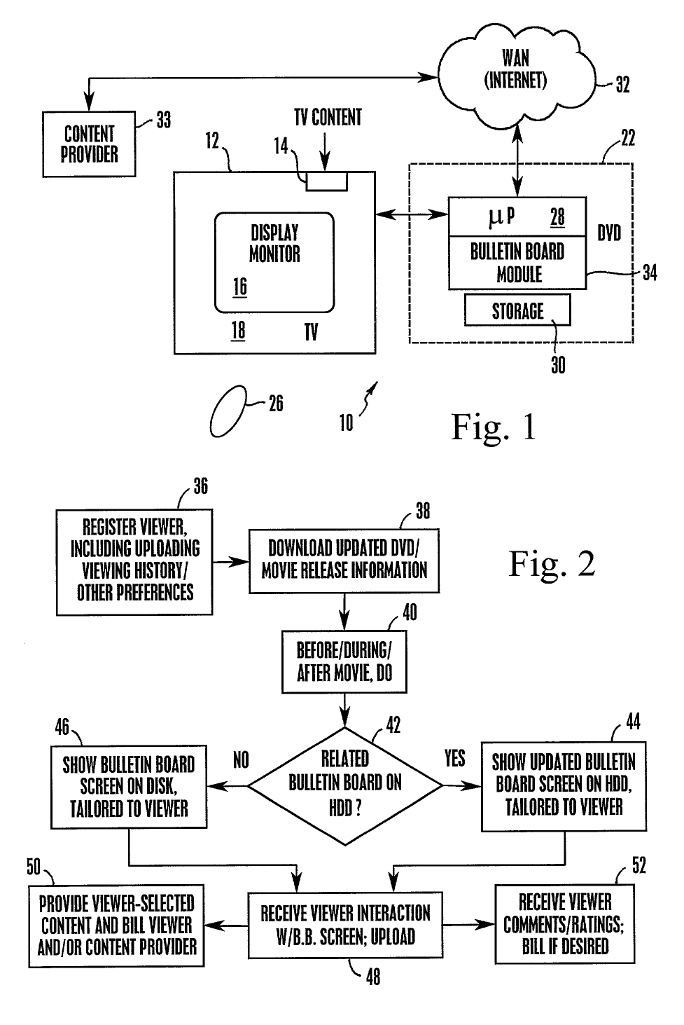

Referring initially to FIG. 1, a system is shown, generally designated 10. As shown, the system 10 includes a TV 12 that conventionally receives televised content at a content receiver 14 (e.g., an antenna, satellite dish, set-top box, etc.) for display of the content on a monitor 16.

While the embodiment below discusses a TV 12 with a single housing that is shown separate from the microprocessor and database, it is to be understood that the term “television” encompasses any apparatus that has a television tuner and the below-described capability in a single housing or in separate housings that cooperate together. For instance, the term “TV” encompasses the television system shown in FIG. 1, as well as a conventional television in combination with an auxiliary component such as a set-top box, DVD player, personal video recorder (PVR), etc., that functions in accordance with the present invention. In the latter example, the auxiliary component might include a microprocessor, discussed below. In another embodiment, the microprocessor discussed below can be a standalone computer such as a PC or laptop with its own monitor (not shown), and can communicate with the TV 12 by wired or wireless link or simply by transferring data from the TV to the computer using, e.g., a floppy diskette.

In the preferred non-limiting embodiment shown, the TV 12 includes a housing 18 that holds a conventional television tuner which receives the TV signals. The audio and video settings of the TV, i.e., the volume, tone, tint, color, contrast, and so on as conventionally provided in the art, are established by respective adjustable audio and video setting circuits. Also, the TV 12 can display media-stored content, including disk-stored content 20, on the monitor 16 that is received from a peripheral recording device associated with the TV, such as but not limited to a DVD player 22 that can play DVD 23 in accordance with principles known in the art. While for convenience a DVD player 22 is assumed, it is to be understood that the present invention also encompasses the use of players other than the DVD player 22, e.g., a CD player or a VCR.

While FIG. 1 shows that the DVD player 22 is separate from the TV housing 18, it is to be understood that the player 22 can be incorporated into the housing 18. In any case, the media-stored content provided from the peripheral device, that is, the player that is associated with the TV, is distinct from broadcast content received from an antenna, satellite dish, or cable. When used without a modifier, however, “content” refers to both media-stored content and to broadcast content.

The content 20 is automatically or selectively displayed by a viewer by appropriately manipulating a remote control user input device 26 or other controls located on the housing 18. It is to be understood that while FIG. 1 shows that the U/I device 26 can be a conventional TV remote control device, other devices can be used, such as but not limited to keyboards, keypads, mice, touch screen technology, voice activation/recognition technology, etc.

A microprocessor 28 can store content in a database 30. As intimated above, the preferred microprocessor 28 is integrated with the TV 12, either in the housing 18 or more preferably in a separate but associated housing such as the DVD player 22 in such a manner as to receive the content automatically.

If desired, the microprocessor 28 can also communicate with a wide area network (WAN) such as but not limited to the Internet 32 via cable or wire modem, DSL link, wireless link, or other network link in accordance with principles known in the art to access computer sites on, e.g., the World Wide Web. For instance, a content provider server or site 33 can be accessed via the WAN 32.

The microprocessor 28 accesses a software-implemented bulletin board module 34 to execute the logic set forth herein. The database 30 can be contained in computer memory, or on a hard disk drive, optical drive, solid state storage, tape drive, removable flash memory, or any other suitable data storage medium.

It may now be appreciated that the microprocessor 28 undertakes the logic below. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. The invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g., the present microprocessors/servers as a series of computer-executable instructions. In addition to residing on hard disk drives, these instructions may reside, for example, in RAM of the appropriate computer, or the instructions may be stored on magnetic tape, electronic read-only memory, or other appropriate data storage device.

Now also referring to the logic diagram shown in FIG. 2, at block 36 the viewer, as represented by the DVD 22 (FIG. 1), is registered with a system server, such as but not limited to the content provider server or site 33 (FIG. 1). In this case, the registration would be effected using the WAN 32. Registration information can include viewer name or other identification, as well as the viewer's entertainment preferences, as might be manually input by the viewer using the remote control U/I device 26 or as might be inferred from the viewer's past viewing history using, as but one non-limiting example, the history-learning principles currently used in a TiVo® device. In one implementation, the viewer preference is established automatically on the basis of the identity of a DVD movie that has just been watched. The viewer preference can be established based on a combination of the above factors.

Proceeding to block 38, updated information regarding the latest movie releases and DVD releases is downloaded over the WAN 32 from, e.g., the content provider server or site 33 to the storage 30 in the DVD player 22. This updated information is presented in the below-described bulletin board screens. The updated information may comprise an existing bulletin board screen in the storage 30 which is updated with new information, or an entirely new version of an older screen which is received into the storage, and the older screen flushed from memory.

The information can include movie and DVD titles, summaries, actor names, theater locations, and so on. In any case, the information preferably is based on the viewer's preferences that were uploaded at block 36. That is, the downloaded information is personalized to the viewer. As a non-limiting illustration, the viewer's preferences might include romance comedies, in which case only new romance-comedy movie and DVD information will be downloaded at block 38. Moreover, the language of the bulletin board screen is the viewer's language, as uploaded at block 36 in response to a viewer having previously selected a playback language on the DVD player 22 in accordance with current DVD player principles.

As an alternative, the updated information can be downloaded from a DVD. In this case, each new DVD would contain, relative to its manufacture date, the latest movie/DVD information. When an older DVD is played subsequent to playing the newer disk, the information from the newer disk can be available in the storage 30.

Next moving to block 40, before, during, or after a DVD movie has been played on the DVD player 22 and displayed on the TV monitor 16, either automatically or in response to a viewer pressing a button on the remote control U/I device 26, a DO loop is entered to present a bulletin board screen on the monitor 16. Proceeding to decision diamond 42, it is determined, for the particular DVD movie being played, whether a related bulletin board has been saved to the storage 30, e.g., to a hard disk drive of the DVD player 22. In making the determination at decision diamond 42, the identification of the disk being played in the DVD player 22 can be compared to the identifications of bulletin board screens saved in the storage 30. In one embodiment, a bulletin board screen for each content provider is downloaded to the DVD player 22. One bulletin board screen per DVD movie or per DVD movie genre or for each DVD movie actor or for each DVD movie content provider, and so on can be used.

If a corresponding updated screen is in the local storage 30, it is displayed on the monitor 16 at block 44. Otherwise, a bulletin board screen that is stored on the disk being played in the DVD player 22 is displayed at block 46. In any case, the latest information regarding additional content the viewer might want to see, personalized to the viewer's preferences and language and tailored to list content that is reconciled with the content on the DVD being played, is displayed at blocks 44 and 46.

Viewer interactions with the bulletin board screen that are facilitated by, e.g., the remote control U/I device 26 can be received at block 48 and uploaded to, e.g., the content provider server/site 33. The interactions can include the selection of a new DVD for purchase or rent, or a new movie to be viewed over cable or satellite, in which case the logic would move to block 50 to provide the content to the viewer via the WAN 32, cable, satellite, mailed disk, or other transmission means. The viewer can be billed and/or the content provider can be billed by a associated or third party server that facilitates the transaction.

The viewer interactions might also include comments and ratings, either input by the viewer spontaneously or in response to a screen prompt, in which case the logic would move from block 48 to block 52. At block 52 the interactions are uploaded, and third party content providers can be sent the viewer ratings and billed, if desired, for such a marketing service. The viewer might be granted shopping coupons, frequent flier miles, etc., as an incentive to input movie comments and ratings.

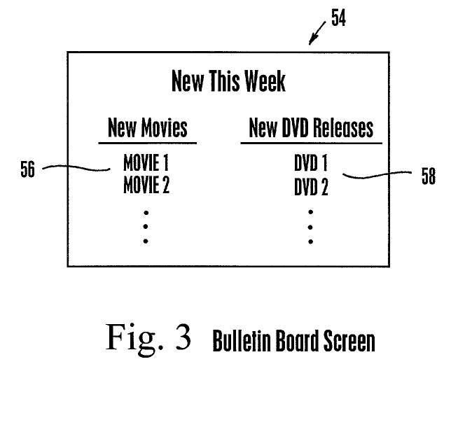

FIG. 3 shows an illustrative bulletin board screen, generally designated 54. As shown, in one non-limiting embodiment the bulletin board screen 54 includes a new movie column 56 and a new DVD release column 58. A movie or DVD can be selected by moving a cursor over the desired movie or DVD and pressing a “select” button or equivalent on the U/I device 26. Likewise, comments and ratings can be entered by appropriately manipulating the U/I device 26.

While the particular SYSTEM AND METHOD FOR PRESENTING DVD BULLETIN BOARD SCREEN PERSONALIZED TO VIEWER as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

What is claimed is:

1. A system for providing information related to a recorded program, comprising:
a TV; and
a digital versatile disk (DVD) player coupled to the TV and including a processor returning recommendations for further viewing based at least partially on at least one viewer preference, such that the information, including recommendations, are personalized to the viewer.

2. The system of claim 1, wherein the viewer preference is established at least in part by a DVD played on the DVD player.

3. The system of claim 2, wherein the information and recommendations are presented in a bulletin board screen displayed on the TV.

4. The system of claim 3, further comprising an input device manipulable to cause the bulletin board screen to be displayed.

5. The system of claim 3, further comprising a storage accessible to the processor and storing updated bulletin board screens.

6. The system of claim 5, wherein the updated screens are received from a wide area computer network (WAN).

7. The system of claim 5, wherein the updated screens are received from a DVD.

8. The system of claim 5, wherein when the processor determines that the bulletin board screen is to be displayed, the processor first determines whether a corresponding updated screen is in the storage and if so, retrieves the updated screen for display, and otherwise the processor displays a bulletin board screen stored on the DVD.

9. The system of claim 1, wherein the recommendations include DVD releases and theater movie releases.

10. The system of claim 1, wherein the information and recommendations are provided in a language selected by a viewer.

11. A method for providing and recommending audio-video programs and/or content based on a viewer selection of disk-stored content played on a TV, comprising:
determining an identity of the disk-stored content; and
based on the identity, displaying a bulletin board screen personalized for at least one viewer of the disk-stored content, the bulletin board screen listing at least one recommendation for content other than the disk-stored content.

12. The method of claim 11, wherein the bulletin board screen is selected from a set of screens.

13. The method of claim 12, wherein at least some screens in the set are periodically updated.

14. The method of claim 12, wherein at least some screens in the set are periodically updated over a WAN.

15. The method of claim 12, wherein at least some screens in the set are periodically updated using disk-stored content.

16. The method of claim 11, wherein the bulletin board screen is presented in a language selected by a viewer.

17. The method of claim 11, wherein the bulletin board screen is stored on a disk along with the disk-stored content.

18. The method of claim 11, further comprising displaying the bulletin board screen in response to a signal from an input device.

19. The method of claim 13, further comprising storing the set of bulletin board screens in a storage accessible to a DVD player.

20. The method of claim 19, further comprising determining whether an updated screen is in the storage and if so, retrieving the updated screen for display, and otherwise displaying a bulletin board screen stored along with the disk-stored content.

21. The method of claim 11, wherein the recommendation includes at least one of: at least one DVD release, and at least one theater movie release.

22. A system, comprising:
a TV;
a disk player coupled to the TV for playing at least one disk having content thereon; and
a processor causing at least one recommendation screen to be displayed on the TV at least in part based on the disk, the recommendation screen including content recommendations personalized for a viewer.

23. The system of claim 22, wherein the recommendation screen is a bulletin board screen.

24. The system of claim 23, wherein the disk is a DVD and the player is a DVD player.

25. The system of claim 24, wherein the processor is held within a housing of the DVD player.

26. The system of claim 25, wherein the bulletin board screen is in a language selected by a viewer.

27. The system of claim 25, wherein the recommendations include at least one of: at least one DVD release, and at least one theater movie release.

28. The system of claim 25, further comprising a remote control user input device manipulable to control the TV and/or DVD player.

29. The system of claim 25, further comprising a storage accessible to the processor and storing updated bulletin board screens.

30. The system of claim 29, wherein the updated screens are received from a wide area computer network (WAN).

31. The system of claim 29, wherein the updated screens are received from a DVD.

32. The system of claim 29, wherein when the processor determines that the bulletin board screen is to be displayed, the processor first determines whether a corresponding updated screen is in the storage and if so, retrieves the updated screen for display, and otherwise the processor displays a bulletin board screen stored on the DVD.
